(19) United States
(12) Patent Application Publication
(10) Pub. No.: US 2007/0208929 A1
(43) Pub. Date: Sep. 6, 2007

(54) DEVICE INFORMATION MANAGEMENTS SYSTEMS AND METHODS

(75) Inventors: Hao-Lin Lin, Taipei (TW); Chung-Ching Huang, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA TECHNOLOGIES, INC., Taipei (TW)

(21) Appl. No.: 11/560,924

(22) Filed: Nov. 17, 2006

Related U.S. Application Data
(60) Provisional application No. 60/778,193, filed on Mar. 2, 2006.

(51) Int. Cl. G06F 9/00

(52) U.S. Cl. 713/2

(57) ABSTRACT

A device information management system comprises an application device and a BIOS ROM. The BIOS ROM comprises at least one specific region storing device information for the application device. The specific region is not used by a BIOS and not within a calculation range for checksum calculation. The BIOS ROM further comprises an index recording an address of the specific region. The application device reads the index from the BIOS ROM, and reads the device information from the specific region according to the index.

### CROSS-REFERENCE TO RELATED APPLICATION

This application claims the benefit of U.S. Provisional Application No. 60/778,193, filed on Mar. 2, 2006.

### BACKGROUND OF THE INVENTION

1. Field of the Invention

The disclosure relates generally to device information management systems and methods, and, more particularly to systems and method that store and manage device information of application devices in an integrated ROM (Read-Only Memory), such as BIOS (Basic Input/Output System) ROM.

2. Description of the Related Art

Cost is an important concern in production/device design. One way to reduce related cost of hardware design is to reduce the size or number of pins of the hardware. For example, to reduce related cost, Flash ROM storing BIOS was originally designed in ISA interface, then in LPC, and then became SPI interface.

Additionally, one way to reduce related cost of hardware design is to fully utilize system resources. Hardware in the system must use data or programs stored in the non-volatile memory. ROM, such as EEPROM (Electrically Erasable Programmable Read-Only Memory) is a type of non-volatile memory device commonly applied in motherboard and component designs of a computer system. Data stored in EEPROM is secure until software or hardware issues an erase command. For example, a LAN (Local Area Network) controller stores data comprising PHY (Physical) ID (identification), MAC (Media Access Control) address and Vendor/System ID used to restore the system from power-saving mode in EEPROM.

FIG. 1 is a schematic diagram illustrating conventional device information management. In the computer system 100, a BIOS ROM 110 storing BIOS 111 is necessary for system boot. Additionally, the computer system 100 further comprises at least an application device such as LAN controller 120 requiring an EEPROM 121 provided to store corresponding information. After the computer system boots, the LAN controller 120 loads device information, such as PHY ID and MAC address from the EEPROM 121, to provide LAN function accordingly. Conventionally, one motherboard or computer system may provide many EEPROMs for respective devices. However, little device information is required for respective application devices, and requires minimal memory space for storage. This conventional practice raises the EEPROM costs.

Generally, the BIOS ROM 110 is not fully occupied by the system BIOS image. Since the property of EEPROM and Flash ROM is similar, the invention stores data required for the BIOS and LAN controller in a Flash ROM having larger space instead of two small memories, thereby reducing the size of the motherboard and the EEPROM costs.

### BRIEF SUMMARY OF THE INVENTION

Device information management systems and methods are provided.

An embodiment of a device information management system comprises an application device and a BIOS ROM. The BIOS ROM comprises at least one specific region storing device information for the application device. The specific region is not used by a BIOS and not within a calculation range for checksum calculation. The BIOS ROM further comprises an index recording an address of the specific region. The application device reads the index from the BIOS ROM, and reads the device information from the specific region according to the index.

In an embodiment of a device information management method, an application device first reads an index from a BIOS ROM. The index records an address of a specific region not used by a BIOS, and not within a calculation range for checksum calculation. Then, the application device reads device information from the specific region according to the index.

In an embodiment of a device information management method, a BIOS ROM is provided, and a BIOS is stored to the BIOS ROM. A space in the BIOS ROM is reserved for an index. A specific region in the BIOS ROM is sought. The specific region is not used by the BIOS and not within a calculation range for checksum calculation. Device information for an application device is stored to the specific region, and an address of the specific region is recorded to the index. The application device can read the device information from the BIOS ROM according to the index.

Device information management systems and methods may take the form of program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating conventional device information management;

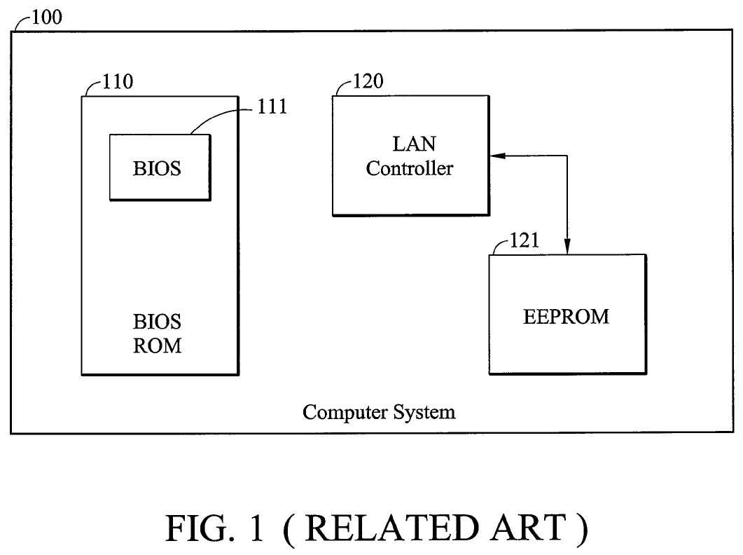

FIG. 2 is a schematic diagram illustrating an embodiment of a device information management system;

FIG. 3 is a schematic diagram illustrating another embodiment of a device information management system;

FIG. 4 is a schematic diagram illustrating still another embodiment of a device information management system;

FIG. 5 is a schematic diagram illustrating an embodiment of a BIOS ROM;

FIG. 6 is a flowchart of an embodiment of BIOS ROM preparation; and

FIG. 7 is a flowchart of an embodiment of device information retrieval.

### DETAILED DESCRIPTION OF THE INVENTION

Device information management systems and methods are provided.

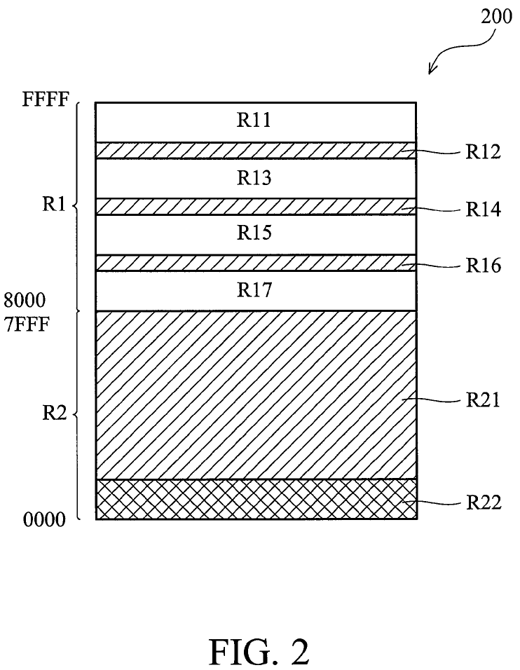

FIG. 2 is a schematic diagram illustrating an embodiment of a device information management system.

The device information management system comprises a ROM, such as Flash ROM 200. Generally, BIOS requires a specific space of 512 KB, for example. In this embodiment, double the specific space, such as 1024 KB is employed for the Flash ROM 200. The BIOS and an application device comprising LAN, VGA, and RAID card controllers share the Flash ROM 200, and store data therein. As shown in FIG. 2, the BIOS remains in the original manner, storing 512 KB data from the top of the Flash ROM in region R1, in which regions R11, R13, R15 and R17 are used, and regions R12, R14, and R16 are not used. The remaining 512 KB in region R2 is for the application device, storing data from address 00000 to 7FFF, in which region R22 is used, and region R21 is not used. It is noted that application device such as LAN controller only requires a small space (about 32 bytes), such that most space reserved for the application device is wasted.

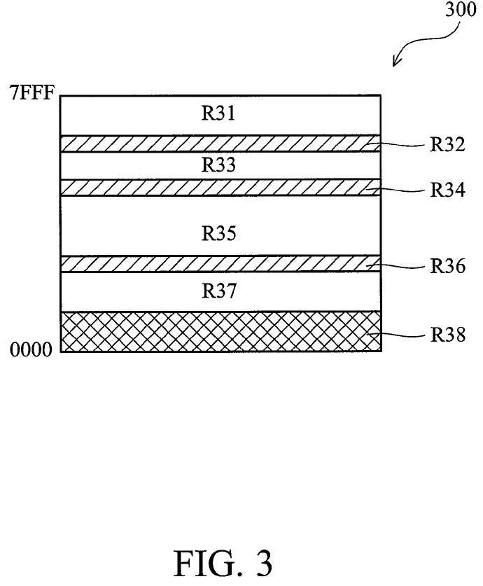

Since free space is available in region R1 reserved for the BIOS (R12, R14, and R16), the free space can store the data for the application device. FIG. 3 is a schematic diagram illustrating another embodiment of a device information management system. The device information management system comprises a ROM, such as Flash ROM 300. The size of the Flash ROM 300 is 512 KB as the general BIOS. The BIOS and the application device share the Flash ROM 300, and store data therein. As shown in FIG. 3, the BIOS stores data in regions R31, R33, R35 and R37, in which regions R32, R34, R36, and R38 are not used. The data for the application device is stored in the region that not used by the BIOS, for example, from address 00000 in region R38.

It is understood that respective BIOS design can define a calculation range in ROM for checksum calculation. The checksum value is used to ensure data integrity after the BIOS is finished. However, the application device such as LAN controller will dynamically access the data in the ROM, which may be changed accordingly. If the accessed data is in the calculation range for checksum calculation, the calculation result may be wrong, result in checksum error, and system boot failure.

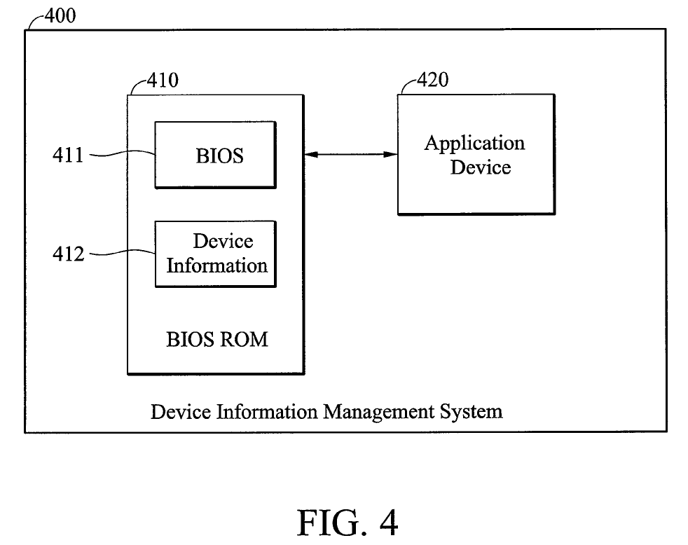

FIG. 4 is a schematic diagram illustrating still another embodiment of a device information management system. The device information management system 400 can be used in a computer system. In this embodiment, the checksum error problem is avoided.

The device information management system 400 comprises an application device 420 and a BIOS ROM 410. The application device 420 may be a LAN, VGA, or RAID card controller. For example, the application device is LAN, requiring device information, such as PHY ID, MAC address, Vendor/System ID, and others to function. The BIOS ROM 410 comprises a BIOS 411 to provide basic input and output, configuration, hardware test functions, and others, to the computer system. The BIOS ROM 410 stores device information 412 of the application device 420.

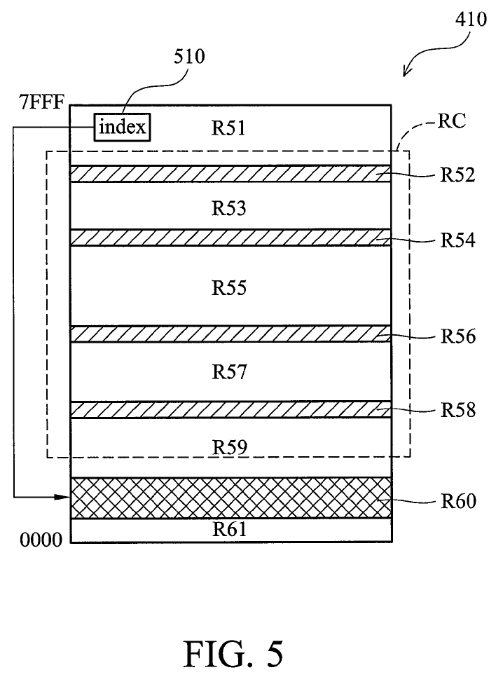

FIG. 5 is a schematic diagram illustrating an embodiment of a BIOS ROM. As shown in FIG. 5, regions R51, R53, R55, R57, R59 and R61 are used to store data of the BIOS 410, and regions R52, R54, R56, R58 and R60 are not used for the BIOS 410. It is noted that a calculation range RC is defined in the BIOS ROM 410 for checksum calculation, with regions R52, R54, R56 and R58 within the range. The free region R60 is used to store data for the application device 420 since it is outside the range. Note that the BIOS ROM 410 further comprises an index 510 to locate the region storing data for the application device 420. In some embodiments, the BIOS ROM 410 may be a SPI Flash ROM, and the address thereof is represented in 24-bit, 3-byte space is provided for the index 510 locating the data for the application device 420.

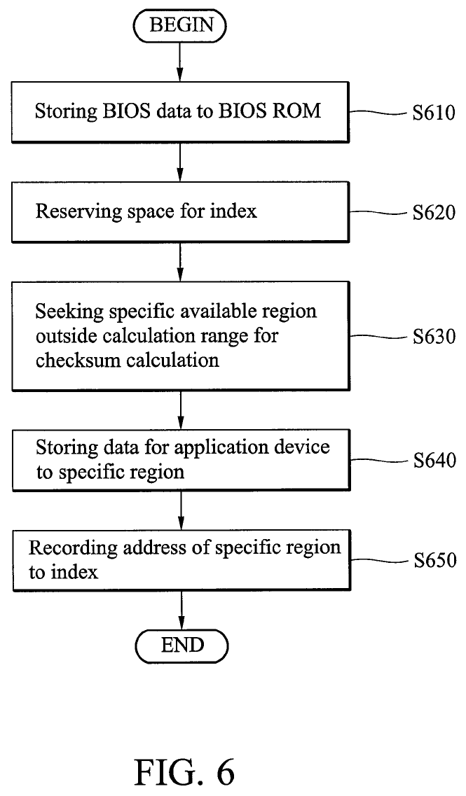

FIG. 6 is a flowchart of an embodiment of BIOS ROM preparation. In step S610, BIOS data is stored to a BIOS ROM. In step S620, a space is reserved for an index. Note that the BIOS can be provided from any BIOS vender, and the address of the index can be determined in BIOS design, and provided to the application device designer. As described, if the BIOS ROM is a 24-bit SPI Flash ROM, the space reserved for the index is 3 bytes. In step S630, a specific available region in the BIOS ROM is sought. It is understood that the specific region reserved for the data of the application is not within the calculation range for checksum calculation. In step S640, data for the application device is stored to the specific region. In step S650, the address of the specific region is recorded to the index.

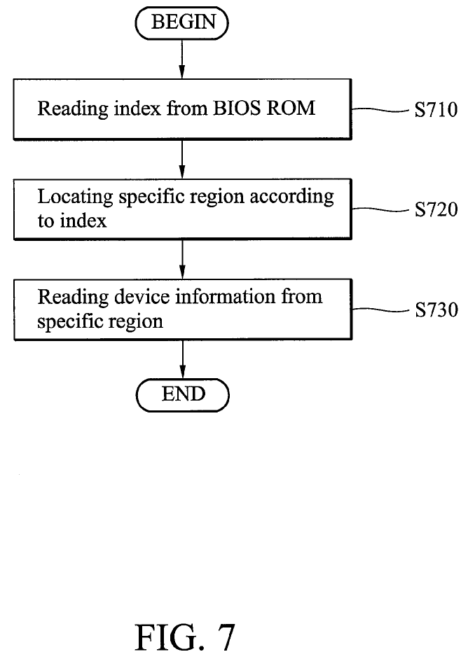

FIG. 7 is a flowchart of an embodiment of device information retrieval. When the computer system boots, in step S710, the application device reads the index in the BIOS ROM. As described, the address of the index is provided to the application device designer in advance. The application device designer can design the index address to the application device, and the application device reads the index therefrom. In step S720, the specific region reserved for the data of the application device is located according to the index, and in step S730, the data in the specific region is read. After the device information is read, the application device can normally function.

In the invention, device information is stored in the remnant space of the BIOS ROM, where a smaller Flash ROM can be used, reducing the cost of motherboard and Flash ROM. Additionally, the BIOS ROM can flexibly provide remnant space not used for checksum calculation to device information for access, where the application device can change the data content arbitrarily, and the change will not generate the checksum error. Therefore, the invention can apply to any kind of BIOS provided by different designers.

Device information management systems and methods, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A device information management system, comprising:
an application device; and
a BIOS (Basic Input/Output System) ROM (Read-Only Memory) comprising at least one specific region storing device information for the application device, in which the specific region is not used by a BIOS and not within a calculation range for checksum calculation, and an index recording an address of the specific region,
wherein the application device reads the index from the BIOS ROM, and reads the device information from the specific region according to the index.

2. The system of claim 1 wherein the application device comprises a LAN (Local Area Network), VGA or RAID card controller.

3. The system of claim 1 wherein the device information comprises a PHY ID (Physical Identification), or MAC (Media Access Control) address if the application device comprises a LAN controller.

4. The system of claim 1 wherein the BIOS ROM is a SPI Flash ROM.

5. A device information management method, comprising:
an application device reading an index from a BIOS (Basic Input/Output System) ROM (Read-Only Memory), in which the index records an address of a specific region not used by a BIOS and not within a calculation range for checksum calculation; and
reading device information from the specific region according to the index.

6. The method of claim 5 wherein the application device comprises a LAN (Local Area Network), VGA or RAID card controller.

7. The method of claim 5 wherein the device information comprises a PHY ID (Physical Identification), or MAC (Media Access Control) address if the application device comprises a LAN controller.

8. The method of claim 5 wherein the BIOS ROM is a SPI Flash ROM.

9. A device information management method, comprising:
providing a BIOS (Basic Input/Output System) ROM (Read-Only Memory);
storing a BIOS to the BIOS ROM;
reserving a space in the BIOS ROM for an index;
seeking a specific region in the BIOS ROM, in which the specific region is not used by the BIOS and not within a calculation range for checksum calculation;
storing device information for an application device to the specific region; and
recording an address of the specific region to the index,
wherein the application device reads the device information from the BIOS ROM according to the index.

10. The method of claim 9 wherein the application device comprises a LAN (Local Area Network), VGA or RAID card controller.

11. The method of claim 9 wherein the device information comprises a PHY ID (Physical Identification), or MAC (Media Access Control) address if the application device comprises a LAN controller.

12. The method of claim 9 wherein the BIOS ROM is a SPI Flash ROM.

13. The method of claim 9 wherein the BIOS is from any BIOS vender.
